(19) United States
(12) Patent Application Publication
(10) Pub. No.: US 2020/0107632 A1
(43) Pub. Date: Apr. 9, 2020

(54) TOOTHBRUSH ASSEMBLY

(71) Applicant: Kangaroo Oral Care, LLC, Cedarhurst, NY (US)

(72) Inventor: Jaime Frand, Cedarhurst, NY (US)

(21) Appl. No.: 16/708,116

(22) Filed: Dec. 9, 2019

Related U.S. Application Data
(63) Continuation-in-part of application No. 16/004,067, filed on Jun. 8, 2018.

(51) Int. Cl. A46B 11/00; A46B 5/02; A46B 9/04; A46B 15/00; G04F 3/06

(52) U.S. Cl. CPC A46B 11/0058; A46B 5/026; A46B 9/04; A46B 11/002; A46B 11/0096; A46B 2200/1066; A46B 15/0081; A46B 15/0008; G04F 3/06; A46B 2200/01; A46B 15/0044

(57) ABSTRACT

A toothbrush assembly comprises an elongated handle portion, a head portion at one end and having toothbrush bristles thereon, and an opposite end within which an indicator, comprising a timer mechanism and a light, is provided for providing the user with a predeterminedly defined timed period for brushing one's teeth. The entire assembly is made as a one-piece assembly such that various components do not become separated from each other, the assembly is fabricated from a thermoplastic material which is transparent such that inner components are visible, and the toothbrush assembly is also adapted to accommodate a three-month supply of toothpaste after the depletion of which the entire assembly can be discarded. A timer is provided for defining the predeterminedly defined timed period, and one or more lights, preferably LEDs, can be illuminated at the end of the timed period or can flash throughout the timed period and then be extinguished at the conclusion of the timed period. Having the lights constantly flash throughout the timed period permits users, particularly children, to brush their teeth in a dark environment, a feature that they may find fun and interesting, and therefore serve as an inducement for them to regularly brush their teeth.

### CROSS REFERENCE TO RELATED PATENT APPLICATIONS

This patent application is a Continuation-in-Part (CIP) of U.S. patent application Ser. No. 16/004,067 which was filed on Jun. 8, 2018, the priority benefits of which are hereby claimed.

### FIELD OF THE INVENTION

The present invention relates generally to toothbrushes, and more particularly to a new and improved toothbrush assembly which comprises various features which are specifically provided in order to assist, aid, or help to train young children not only in the importance of brushing their teeth properly, but to brush their teeth for a predetermined period of time so as to best ensure that the brushing of their teeth is complete whereby all regions of the teeth are in fact brushed, and in addition, to effectively make the brushing of their teeth more fun so that they will enthusiastically look forward to brushing their teeth on a regular basis.

### BACKGROUND OF THE INVENTION:

A toothbrush is an oral hygiene instrument used to clean the teeth, gums, and tongue. It consists of a head of tightly clustered bristles mounted upon a distal end of a handle which facilitates the cleaning of hard-to-reach areas of the mouth. Toothbrushes are available with different bristle textures or stiffness properties, differently sized bristles, and different patterns or arrangements of the bristles. Most dentists recommend using a toothbrush which has relatively soft bristles since toothbrushes with relatively hard bristles can damage tooth enamel and/or irritate the gums.

Toothpaste is a paste or gel dentifrice which is utilized in conjunction with a toothbrush as an accessory to clean and maintain the aesthetics and health of the teeth. Toothpaste is used to promote oral hygiene in that it serves as a mild abrasive that aids in removing dental plaque and food from the teeth, assists in suppressing halitosis, and delivers active ingredients, such as, for example, fluoride, in order to help prevent tooth decay, such as, for example, dental caries, as well as gum disease, such as, for example, gingivitis. Salt and sodium bicarbonate, or baking soda, are materials that can be substituted for commercial toothpaste, or in fact, can be incorporated within commercial toothpaste. Toothpaste is not intended to be swallowed due to the incorporation of the fluoride within its composition, however, it is generally not very harmful if accidentally swallowed in small amounts. Nevertheless, one should seek medical attention if abnormally large amounts of toothpaste have in fact been swallowed.

Currently, there are a multitude of toothbrush assemblies which can dispense toothpaste, however, such conventional toothbrush assemblies are usually deficient in connection with one or more properties, features, or manner of use that consumers desire when selecting a toothbrush assembly. For example, in connection with one known type of toothbrush assembly, the toothbrush assembly houses a supply of toothpaste internally within the toothbrush assembly handle section, however, in order to access the supply of toothpaste, the head of the toothbrush assembly, upon which the toothbrush bristles are disposed, must first be removed from the handle section of the toothbrush assembly, a predetermined amount of toothpaste is then dispensed onto the bristles of the toothbrush, and then the head of the toothbrush assembly must then be reassembled onto the handle section of the toothbrush assembly so that the user can conveniently manipulate the toothbrush assembly so as to properly brush one's teeth. Another conventional type of toothbrush assembly comprises a mechanism which permits the user to dispense the toothpaste from a toothpaste storage supply section defined internally within the toothbrush assembly, however, the deficiency characteristic of this toothbrush assembly is that there is no control over the amount of toothpaste being dispensed, hence, during a first time of use, not enough toothpaste may be dispensed, whereas during a second time of use, an excess amount of toothpaste is dispensed. Still further, another conventional type of toothbrush assembly may contain a replaceable toothpaste canister that is, for example, inserted through or into the bottom end portion of the toothbrush assembly, however, again, there is no control mechanism for effectively regulating the amount of toothpaste that is dispensed, and, in addition, this type of conventional toothbrush assembly is relatively expensive considering the costs of replacing the depleted toothpaste canisters.

A need therefore exists in the art for a new and improved toothbrush assembly. An additional need exists in the art for a new and improved toothbrush assembly which is simple in construction. A still additional need exists in the art for a toothbrush assembly which effectively comprises a one-piece construction. A yet additional need exists in the art for a toothbrush assembly which effectively comprises a one-piece construction and is relatively inexpensive to manufacture. A further need exists in the art for a toothbrush assembly which is effectively comprises a one-piece construction and is relatively inexpensive to manufacture such that when the supply of toothpaste incorporated within the toothbrush assembly is depleted, the toothbrush assembly can simply be discarded. A still further need exists in the art for a new and improved toothbrush assembly which, while capable of being used by anyone, is specifically oriented toward children. A yet further need exists in the art for a new and improved toothbrush assembly which, while capable of being used by anyone, is specifically oriented toward children and must therefore be safe to use. A yet still further need exists in the art for a new and improved toothbrush assembly which, while capable of being used by anyone, is specifically oriented toward children so as to be user friendly. A still yet further need exists in the art for a new and improved toothbrush assembly which, while capable of being used by anyone, is specifically oriented toward children so as to effectively teach them about the importance of brushing their teeth properly. Another need exists in the art for a new and improved toothbrush assembly which, while capable of being used by anyone, is specifically oriented toward children so as to effectively teach them about the importance of brushing their teeth for a predetermined period of time so as to best ensure that the brushing of their teeth is complete whereby all regions of the teeth are in fact brushed. Still another need exists in the art for a new and improved toothbrush assembly which, while capable of being used by anyone, is specifically oriented toward children so as to effectively not only teach them about the importance of brushing their teeth, but in addition, to effectively make the brushing of their teeth more fun so that they will enthusiastically look forward to brushing their teeth on a regular basis.

### OVERALL OBJECTIVES OF THE INVENTION

A first overall objective of the present invention is to provide a new and improved toothbrush assembly. An additional overall objective of the present invention is to provide a new and improved toothbrush assembly which is simple in construction. A still additional overall objective of the present invention is to provide a toothbrush assembly which effectively comprises a one-piece construction. A yet additional overall objective of the present invention is to provide a toothbrush assembly which effectively comprises a one-piece construction and is relatively inexpensive to manufacture. A further overall objective of the present invention is to provide a toothbrush assembly which is effectively comprises a one-piece construction and is relatively inexpensive to manufacture such that when the supply of toothpaste incorporated within the toothbrush assembly is depleted, the toothbrush assembly can simply be discarded. A still further overall objective of the present invention is to provide a new and improved toothbrush assembly which, while capable of being used by anyone, is specifically oriented toward children. A yet further overall objective of the present invention is to provide a new and improved toothbrush assembly which, while capable of being used by anyone, is specifically oriented toward children and must therefore be safe to use. A yet still further overall objective of the present invention is to provide a new and improved toothbrush assembly which, while capable of being used by anyone, is specifically oriented toward children so as to be user friendly. A still yet further overall objective of the present invention is to provide a new and improved toothbrush assembly which, while capable of being used by anyone, is specifically oriented toward children so as to effectively teach them about the importance of brushing their teeth properly. Another overall objective of the present invention is to provide a new and improved toothbrush assembly which, while capable of being used by anyone, is specifically oriented toward children so as to effectively teach them about the importance of brushing their teeth for a predetermined period of time so as to best ensure that the brushing of their teeth is complete whereby all regions of the teeth are in fact brushed. Still another overall objective of the present invention is to provide a new and improved toothbrush assembly which, while capable of being used by anyone, is specifically oriented toward children so as to effectively not only teach them about the importance of brushing their teeth, but in addition, to effectively make the brushing of their teeth more fun so that they will enthusiastically look forward to brushing their teeth on a regular basis. A last overall objective of the present invention is to provide a new and improved toothbrush assembly which, while capable of being used by anyone, is specifically oriented toward children and is specifically manufactured so as to be relatively light in weight so as to easily held and manipulated by children.

### SUMMARY OF THE INVENTION

The foregoing and other objectives are achieved in accordance with the principles and teachings of the present invention by providing a toothbrush assembly wherein, in accordance with a first embodiment of the toothbrush assembly, the toothbrush assembly comprises an elongated body or handle portion and a head portion fixedly mounted upon one end of the elongated body or handle portion and upon which a plurality of toothbrush bristles are mounted in a predetermined pattern or arrangement. A reservoir is defined within the elongated body or handle portion of the toothbrush assembly so as to contain a predetermined supply of toothpaste, such as, for example, approximately a three-month of toothpaste when one brushes one's teeth in accordance with currently acceptable dental recommendations, such as for example at least once or twice per day, after the depletion of which, the toothbrush assembly may be discarded. A slidable actuator is movably mounted upon the elongated body or handle portion so as to, in turn, actuate a plunger mechanism which will cause a predetermined amount of toothpaste to be dispensed from the toothpaste reservoir, disposed within the elongated body or handle portion of the toothbrush assembly, onto the toothbrush bristles of the toothbrush assembly so as to permit the person to then brush his or her teeth. In addition, the toothbrush assembly is provided with a timer and various alarms, such as, for example, one or more LED lights whereby the timer may be set for a predetermined time period during which the person or child is to brush his or her teeth. At the end of the predetermined time period, the one or more LED lights will flash so as to visually indicate that the predetermiedly timed brushing period is complete. Still yet further, other visual or tactile indicators may also be utilized.

In accordance with a second embodiment of the present invention, in lieu of the slidable actuator and plunger mechanism as disclosed within the first embodiment, a rotary actuator is provided, wherein, when the actuator mechanism is rotated in either one of two opposite directions, a predetermined amount of toothpaste will be dispensed onto the toothbrush bristles, whereas when the actuator mechanism is released so as to permit the actuator mechanism to return to its original position in a second opposite direction, a predetermined amount of toothpaste will effectively be pre-loaded into the dispensing housing portion so as to be ready to be dispensed onto the toothbrush bristles when the actuator mechanism is again angularly rotated in either one of the two opposite directions. An additional feature of the second embodiment of the present invention toothbrush assembly is the fact that the entire toothbrush assembly effectively comprises a one-piece structural component so that parts of the toothbrush assembly cannot become disconnected from each other or lost. Still further, the housing or elongated boy or handle portion is fabricated from a suitable thermoplastic material which is transparent such that the internal components of the toothbrush assembly are visible. This feature is submitted to be interesting to young children who always seem to have a thirst for knowledge as to how different structures are made or how the components of a system operatively cooperate together so as to cause the commercial item that they are using to operate in the way that it does. Lastly, as was the case with the first embodiment, a timer is provided for effectively programming a predetermined time period into the toothbrush assembly, such as, for example, two minutes, during which the person or child is to use the toothbrush to properly and completely brush their teeth, and one or more LED lights are also provided, however, in this second embodiment of the toothbrush assembly, the one or more LED lights are adapted to be illuminated in a constant or flashing manner throughout the two-minute tooth brushing period, at the end of which, when the timer mechanism times out, the one or more LED lights will be extinguished, indicating the completion of the tooth brushing operation. This feature is deemed to render the tooth brushing operation more fun to children in that they can effectively brush their teeth in, for example, a darkened bathroom. Lastly, the toothbrush assembly is relatively light in weight, such as, for example, is less than three ounces, so as to effectively render the same easy to be held and manipulated by children.

### BRIEF DESCIRPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is an exploded view of a first embodiment of a disposable toothbrush assembly as developed in accordance with the principles and teachings of the present invention;

FIG. 2 is a perspective view of the toothbrush assembly as illustrated within FIG. 1 and showing the use of the same by means of a user so as to dispense toothpaste onto the bristles of the toothbrush;

FIG. 3 is a partial perspective of the toothbrush assembly as illustrated within FIGS. 1 and 2 and showing a person activating the timer mechanism mounted within the bottom end portion of the toothbrush assembly housing;

FIG. 4 is an enlarged view of the timer mechanism which is adapted to be mounted within the bottom end portion of the toothbrush assembly housing but shown separately from the toothbrush assembly;

FIG. 5 is a perspective view of the toothbrush assembly being used by a person to brush their teeth; and

FIG. 6 is a perspective view of a second embodiment of a toothbrush assembly also developed in accordance with the principles and teachings of the present invention.

### DETAILED DESCRIPTION OF THE PREFERRED EMBODIMENT

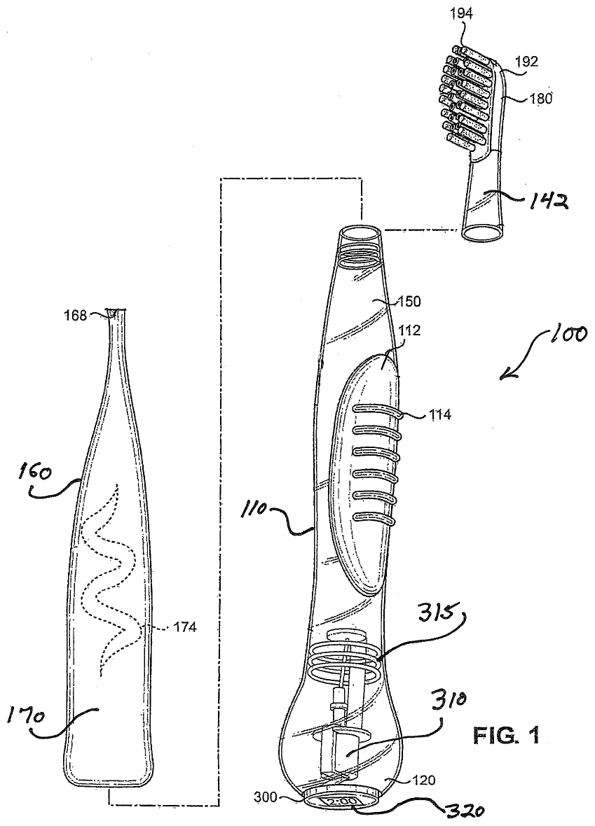

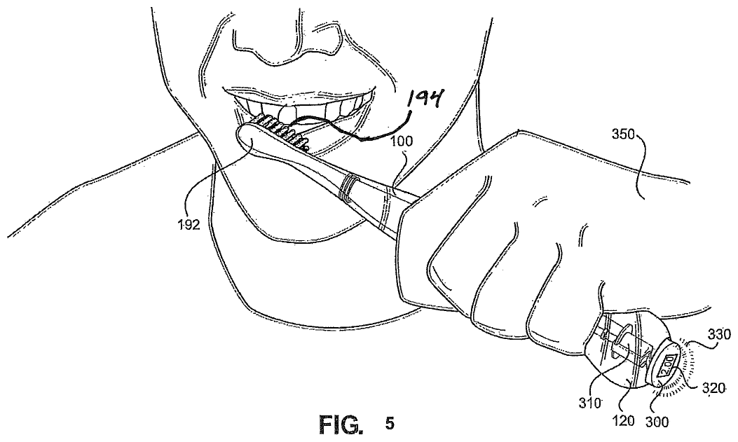

Referring now to the drawings, and more particularly to FIGS. 1-5 thereof, a first embodiment of the present invention will be described, and it is seen that the first embodiment of the toothbrush assembly is disclosed and is generally indicated by means of the reference number 100. More particularly, it is seen that the toothbrush assembly 100 comprises an elongated main body portion or handle 110, and a toothpaste container 160 which is adapted to be disposed internally within the elongated main body portion or handle 110. The toothpaste container 160 comprises an internal volume 170 within which a predetermined supply of toothpaste 174, such as, for example, a three-month supply of toothpaste, is disposed, and it is additionally seen that the upper end of the toothpaste container 160 is provided with an aperture 168 through which the toothpaste 174 can flow into the upper head portion 180 of the toothbrush assembly 100 so as to, in turn, flow through a slot 142 defined within the upper head portion 180 of the toothbrush assembly 100 whereby the toothpaste can flow onto or between the bristles 194 of the upper head portion 180 of the toothbrush assembly 100 when the upper head portion 180 of the toothbrush assembly 100 is fixedly mounted atop the upper end portion 150 of the elongated main body portion or handle 110 of the toothbrush assembly 100. It is to be noted that the elongated main body portion or handle 110 may be fabricated from a suitable thermoplastic material which is transparent such that the internal components of the toothbrush assembly 100 are visible as will be noted more fully hereinafter.

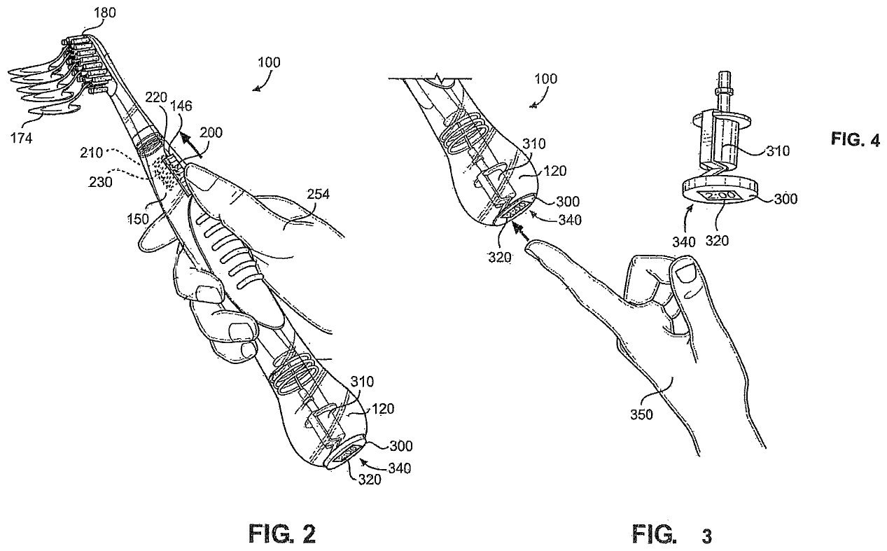

It is further seen that the axially central, external portion of the elongated main body portion or handle 110 is provided with one or more hand-grip members 112 which, in turn, have a plurality of ridges or dimples 114 integrally formed thereon so as to provide the user with tactile structures such that the person can firmly grip and hold the toothbrush assembly 100. In addition, as can best be seen in FIG. 2 of the drawings, a slider mechanism 200 is slidably mounted upon an external portion of the elongated main body portion or handle 110, at a location just above one of the hand-grip member 112, so as to be capable of being conveniently actuated by one's thumb 254 as illustrated. The slider mechanism 200, which comprises a button 220 which is adapted to be engaged by means of the thumb 254 of the person using the toothbrush assembly 200, is movable within a longitudinal slot 146, and is operatively connected to a plunger mechanism 210. A spring member 230 is interposed between the slider mechanism 200 and the plunger mechanism 210 such that when the slider mechanism 200 is moved forwardly, the plunger mechanism 210 will encounter the toothpaste container 160 so as to force a predetermined amount of toothpaste 174, disposed within the toothpaste container 160, out from the toothpaste container 160 whereby the dispensed toothpaste 174 can flow through the open end or aperture 168 of the toothpaste container 160, through the slot 142 defined within the head portion 180 of the toothbrush assembly 100, and onto or between the bristles 194 of the head portion 180 of the toothbrush assembly 100. Conversely, when the thumb 254 of the person is removed from the slider mechanism 200, the spring member 230 will return the slider mechanism 200 to its original position. It is further noted that a tongue scraper 192 is also provided upon an underside portion of the head portion 180 of the toothbrush assembly 100 and may be fabricated from silicone rubber or other similar material.

Continuing further, and with reference continuing to be made to FIGS. 1-5, it is additionally seen that the toothbrush assembly 100 further comprises a timing mechanism 300 which is mounted within a lower end portion 120 of the elongated main body or handle portion 110 of the toothbrush assembly 100 wherein the timing mechanism 300 is adapted to provide the user 350 with a warning signal when a predetermined brushing time period, such as, for example, two minutes, has expired or elasped. More particularly, it is seen that the timing mechanism 300 comprises a power supply 310, a timer and visual display 320, and a light member 330. The light member 330 can be any suitable type of light source, but in particular, is noted a preferably comprising one or more LED lights, and it is of course appreciated that the light member 330 and the timer 320 are electrically powered by means of the power supply 310. More specifically, the timer 320 can be set for a predetermined period of time, such as, for example, two minutes, during which the person or user brushing his or her teeth will perform a complete brushing operation, at the end of which time, the light member 330 will be illuminated, indicating to the user that the brushing time has expired or lapsed. Alternatively, the light member 330, comprising the one or more LED lights, can comprise constant illumination, or flashing illumination, during the entire brushing period of two minutes, at the end of which the light member 330, comprising the one or more LED lights, will be extinguished, again indicating to the user that the predetermined brushing time as expired or lapsed. The constant or flashing LED lights during the two-minute brushing time may be particularly interesting or amenable to children in that they can brush their teeth in a darkened environment, such as a darkened bathroom, with the only illumination coming from the one or more LED lights. Alternatively, other audible or tactile indicators, such as, for example, a buzzer or vibrator, may be utilized in lieu of, or in addition to, the one or more LED lights. It is lastly noted that a push-button 340 is provided for starting the timer mechanism 320.

Still yet further, it is seen that a coil spring 315 is operatively connected to the power supply 310 so as to effectively not only support the lower end portion of the toothpaste container 160, but to impart a predetermined force to the same so as to constantly bias the toothpaste container 160 upwardly and thereby effectively ensure that the lower end of the toothpaste container 160 is continuously moved upwardly or collapsed so as to, in turn, ensure that a supply of toothpaste is continually available within the upper end of the toothpaste container 160 so as to be dispensed when the user's thumb 254 activates the slider mechanism 200 and the plunger mechanism 210. In this manner, it can be ensured that the supply of toothpaste 174, disposed within the toothpaste container 160, will be properly consumed and exhausted such that the particular consumer or owner of the toothbrush assembly 100 will effectively be provided with an entire three-month supply of toothpaste 174.

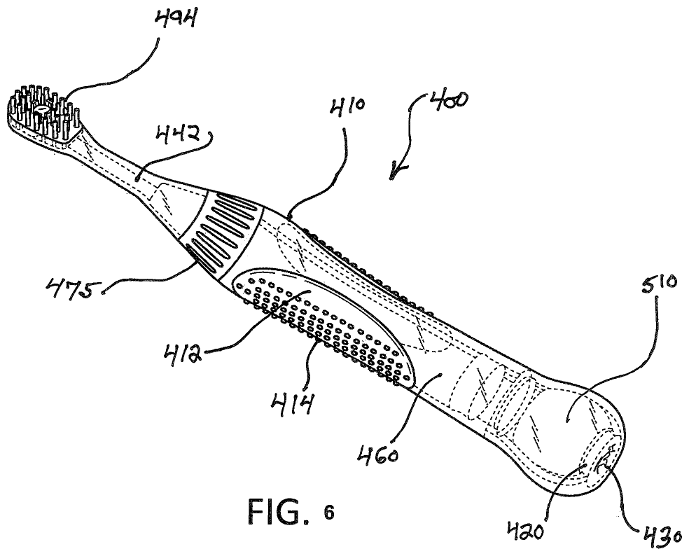

With reference now being made to FIG. 6, and in accordance with a second embodiment of the present invention toothbrush assembly, as is generally indicated by the reference character 400, in lieu of the slidable actuator and plunger mechanism as disclosed within the first embodiment of the toothbrush assembly 100, a rotary actuator is provided, as will be more fully described hereinafter. It is initially noted that with respect to the overall second embodiment of the toothbrush assembly 400, all component parts thereof which correspond to similar components of the first embodiment of the toothbrush assembly 100, will be designated by corresponding reference numbers except that they will be within the 400 and 500 series. Accordingly, and more particularly, and has already been briefly noted, the second embodiment of the toothbrush assembly 400 includes a rotary actuator 475 wherein, when the actuator mechanism 475 is rotated in either one of two opposite directions, a predetermined amount of toothpaste will be dispensed onto the toothbrush bristles, whereas when the actuator mechanism 475 is released so as to permit the actuator mechanism to return to its original position in a second opposite direction, a predetermined amount of toothpaste will effectively be pre-loaded into a dispensing housing portion, not shown, so as to be ready to be dispensed onto the toothbrush bristles 494 when the actuator mechanism 475 is again angularly rotated in either one of the two opposite directions. The actuator mechanism may effectively be operational in a manner similar to a conventional one-way pump dispenser such as, for example, the pump dispenser disclosed within U.S. Pat. No. 8,056,771 which issued to Rossignol on Nov. 15, 2011. As was the case with the first embodiment of the toothbrush assembly of the present invention, the entire toothbrush assembly effectively comprises a one-piece structural component so that parts of the toothbrush assembly cannot become disconnected from each other or lost. Still further, the housing or elongated boy or handle portion is fabricated from a suitable thermoplastic material which is transparent such that the internal components of the toothbrush assembly are visible. As has been noted, this feature is submitted to be interesting to young children who always seem to have a thirst for knowledge as to how different structures are made or how the components of a system operatively cooperate together so as to cause the commercial item that they are using to operate in the way that it does. Lastly, as was the case with the first embodiment, a timer 420 is provided for effectively programming a predetermined time period into the toothbrush assembly, such as, for example, two minutes, during which the person or child is to use the toothbrush to properly and completely brush their teeth, and one or more LED lights, not shown, are also provided. This feature is deemed to render the tooth brushing operation more fun to children in that they can effectively brush their teeth in, for example, a darkened bathroom.

Obviously, many variations and modifications of the present invention are possible in light of the above teachings. It is therefore to be understood that within the scope of the appended claims, the present invention may be practiced otherwise than as specifically described herein.

### REFERENCE NUMBER KEY

100—Toothbrush assembly
110—Elongated handle or body portion
112—Hand-grip members
114—Ridges or dimples on 112
120—Lower end portion of handle 110
142—Slot within upper head portion of toothbrush assembly
146—Slot for movement of slider mechanism 200
150—Upper end portion of elongated body portion
160—Toothpaste container
168—Aperture in upper end of toothpaste container 160
170—Internal volume of toothpaste container 160
174—Toothpaste in container 160
180—Upper head portion of toothbrush assembly
192—Tongue scraper
194—Toothbrush bristles
200—Slider mechanism
210—Plunger mechanism
220—Button on slider mechanism 200
230—Spring mechanism
254—Thumb of person using the toothbrush assembly
300—Timing mechanism
310—Power supply
315—Coil Spring
320—Timer and visual display of timing mechanism 300
330—Light member
340—Push-button for timer 320
350—Person's hand
400—Second embodiment toothbrush assembly
410—Elongated handle or body portion
412—Hand-grip members
414—Dimples or ridges on hand-grip members 412
420—Timer and visual display
430—Light member
442—Slot in upper head portion of toothbrush assembly
460—Toothpaste container
475—Rotary actuator
494—Toothbrush bristles
510—Lower end portion of handle 410

What is claimed as new and desired to be protected by Letters Patent, is:

1. A disposable tooth brush assembly, comprising:
a body portion defining a hollow interior portion within which a predetermined amount of toothpaste is capable of being stored;
a handle portion defined upon a first end of said body portion;
a head portion defined upon a second opposite end of said body portion;
a plurality of bristles mounted upon said head portion;
a fluid conduit defined within said body portion for fluidically connecting said hollow interior portion, within which the predetermined amount of toothpaste is capable of being stored, with said plurality of bristles so as to permit toothpaste to flow from said hollow interior portion to said plurality of bristles;
an actuator for causing a predetermined amount of toothpaste to be dispensed from said hollow interior portion, through said fluid conduit, and to said plurality of bristles; and
an indicator mounted upon said body portion for indicating to the user of said tooth brush assembly that a predetermined amount of brushing time has elapsed whereby the user can be confident that he/she has brushed his/her teeth for a sufficient amount of time;
wherein said body is fabricated from a thermoplastic material which is transparent such that inner components of said toothbrush assembly are visible.

2. The toothbrush assembly as set forth in claim 1, wherein:
said predetermined amount of toothpaste comprises approximately a three-month supply of toothpaste in accordance with normally recommended brushing standards of brushing frequency.

3. The toothbrush assembly as set forth in claim 2, wherein:
said toothbrush assembly is discardable such that after the depletion of said three-month supply of toothpaste, said toothpaste assembly is discarded and replaced with a new toothbrush assembly having a fresh or new supply of toothpaste.

4. The tooth brush assembly as set forth in claim 1, further comprising:
gripping members attached to side portions of said handle portion of said toothbrush assembly so as to enable a user to grip said toothbrush assembly.

5. The toothbrush assembly as set forth in claim 4, further comprising:
dimple members integrally formed upon said gripping members so as to enhance the tactile gripping of said body portion of said toothbrush assembly.

6. The toothbrush assembly as set forth in claim 1, wherein:
said indicator comprises a timer mechanism.

7. The toothbrush assembly as set forth in claim 6, further comprising:
a push-button for actuating said timer mechanism.

8. The toothbrush assembly as set forth in claim 6, wherein:
said predetermined amount of time, timed by said timer mechanism, comprises two minutes.

9. The toothbrush assembly as set forth in claim 6, further comprising:
at least one light which provides a signal that said predetermined amount of time has expired.

10. The toothbrush assembly as set forth in claim 9, wherein:
said at least one light comprises an LED light.

11. The toothbrush assembly as set forth in claim 9, wherein:
said at least one light is illuminated when said timer mechanism begins said predetermined timed period for brushing one's teeth, and is extinguished upon the expiration of the timed period.

12. The toothbrush assembly as set forth in claim 9, wherein:
said at least one light constantly flashes during said predetermined timed period.

13. The toothbrush assembly as set forth in claim 9, wherein:
said at least one light is normally OFF but will be illuminated upon the expiration of said predetermined timed period.

14. The toothbrush assembly as set forth in claim 9, further comprising:
a power supply disposed within said body portion of said toothbrush assembly for powering both said timer mechanism and said at least one light.

15. The toothbrush assembly as set forth in claim 1, wherein:
said actuator comprises a slidable actuator.

16. The toothbrush assembly as set forth in claim 1, wherein:
said actuator comprises a rotary actuator.

17. The toothbrush assembly as set forth in claim 1, further comprising:
a tongue scraper mounted upon said head portion of said toothbrush assembly.

18. The toothbrush assembly as set forth in claim 17, wherein:
said tongue scraper is fabricated from a silicone material.

19. The toothbrush assembly as set forth in claim 1, wherein:
said toothbrush assembly is relatively light in weight, said weight being less than three ounces, so as to be capable of being easily held and manipulated by children.

20. A disposable tooth brush assembly, comprising:
a body portion defining a hollow interior portion within which a predetermined amount of toothpaste is capable of being stored;
a handle portion defined upon a first end of said body portion;
a head portion defined upon a second opposite end of said body portion;
a plurality of bristles mounted upon said head portion;
a fluid conduit defined within said body portion for fluidically connecting said hollow interior portion, within which the predetermined amount of toothpaste is capable of being stored, with said plurality of bristles so as to permit toothpaste to flow from said hollow interior portion to said plurality of bristles;
an actuator for causing a predetermined amount of toothpaste to be dispensed from said hollow interior portion, through said fluid conduit, and to said plurality of bristles; and
an indicator mounted upon said body portion for indicating to the user of said tooth brush assembly that a predetermined amount of brushing time has elapsed whereby the user can be confident that he/she has brushed his/her teeth for a sufficient amount of time;
wherein said toothbrush assembly is fabricated from a thermoplastic material as a one-piece component such that different components of said toothbrush assembly cannot be readily separated.

21. A disposable tooth brush assembly, comprising:
a body portion defining a hollow interior portion within which a predetermined amount of toothpaste is capable of being stored;
a handle portion defined upon a first end of said body portion;
a head portion defined upon a second opposite end of said body portion;
a plurality of bristles mounted upon said head portion;
a fluid conduit defined within said body portion for fluidically connecting said hollow interior portion, within which the predetermined amount of toothpaste is capable of being stored, with said plurality of bristles so as to permit toothpaste to flow from said hollow interior portion to said plurality of bristles;
an actuator for causing a predetermined amount of toothpaste to be dispensed from said hollow interior portion, through said fluid conduit, and to said plurality of bristles; and
an indicator mounted upon said body portion for indicating to the user of said tooth brush assembly that a predetermined amount of time has elapsed whereby the user can be confident that he/she has brushed his/her teeth for a sufficient amount of time;
wherein said indicator comprises at least one light which constantly flashes throughout said predetermined amount of time such that a person can brush one's teeth within a darkened environment.
